(19) United States
(12) Patent Application Publication
(10) Pub. No.: US 2024/0249369 A1
(43) Pub. Date: Jul. 25, 2024

(54) SYSTEMS AND METHODS FOR PROVIDING A SOCIAL NETWORK

(71) Applicant: The Verse Social Club LLC, Dix Hills, NY (US)

(72) Inventors: Anthony Macaluso, Dix Hills, NY (US); Beth-Eileen Walker, Dix Hills, NY (US)

(73) Assignee: The Verse Social Club LLC, Dix Hills, NY (US)

(21) Appl. No.: 18/421,062

(22) Filed: Jan. 24, 2024

Related U.S. Application Data
(60) Provisional application No. 63/481,301, filed on Jan. 24, 2023.

(51) Int. Cl. G06Q 50/00; G06Q 30/0207

(52) U.S. Cl. CPC G06Q 50/01; G06Q 30/0207

(57) ABSTRACT

A system provides a social network. The system is configured to implement the social network as a Web 3.0 platform. The database stores user account records and data associated with user virtual spaces, each user account record and each user virtual space is associated with one of the users. Each user application is stored in memory of a user device associated with one of the users. A server system includes a processor programmed to execute the system execution program for each user and to perform the steps of allowing the user, via the user application, to establish and maintain the associated virtual space, allowing the user, via the user application, to create and maintain content within the associated virtual space, and aggregating the content of the user to Web 2.0 platforms and allowing users to interact with the content on the Web 2.0 platforms.

### CROSS REFERENCE TO RELATED APPLICATIONS

This application claims priority to U.S. Provisional Patent Application Ser. No. 63/481,301 filed on Jan. 24, 2023, the entire disclosure of which is hereby incorporated by reference and relied upon.

### FIELD OF THE INVENTION

The invention relates generally to social network platforms, and more particularly to a

Web 3.0 social blockchain platform.

### BACKGROUND OF THE INVENTION

Virtual social network or social media platforms may allow users to create, share and otherwise access different types of media, pictures, photographs, videos, audio files, text documents. Some virtual social networks allow some users, e.g., influencers to use the platform to share media and to generate a number of followers. The present invention is aimed at allowing such users to interact with their followers in multiple ways or channels to generate a greater following.

### BRIEF SUMMARY OF THE INVENTION

In one aspect of the present invention, a system for providing a social network to a plurality of users, is provided. The system includes a memory device, a database, a server system, and user application. The memory device stores a system executing program including computer instructions. The system executing program is configured to implement the social network as a Web 3.0 platform. The database stores user account records and data associated with user virtual spaces, each user account record and each user virtual space is associated with one of the users. Each user account includes a current level, a number of engagement points, and a virtual currency value. Each user application is stored in memory of a user device associated with one of the users. The server system is coupled to the memory device, the database and the user applications. The server system includes a processor programmed to execute the system execution program for each user and to perform the steps of allowing the user, via the user application, to establish and maintain the associated virtual space, allowing the user, via the user application, to create and maintain content within the associated virtual space, and aggregating the content of the user to Web 2.0 platforms and allowing users to interact with the content on the Web 2.0 platforms. The server system performs the steps of allowing the user, via the user application, to interact with content in the virtual spaces associated with other users; providing, and storing within the user account, engagement points and/or virtual currency as a function of the interaction with the content in the virtual spaces associated with other users; and managing the user's current level as a function of the engagement points and/or virtual currency stored in their account.

In another aspect of the present invention, a method system for providing a social network to a plurality of users. The method includes the step of: storing a system executing program including computer instructions, in a memory device; storing user account records and data associated with user virtual spaces in a database; providing user applications, each user application, stored in memory of a user device associated with one of the users; executing the system execution program for each user on a processor of a server system coupled to the memory device, the database and the user applications; and providing user applications, each user application, stored in memory of a user device associated with one of the users. The system executing program is configured to implement the social network as a Web 3.0 platform. Each user account record and each user virtual space being associated with one of the users. Each user account includes a current level, a number of engagement points, and a virtual currency value. The system execution program for each user is executed on a processor of a server system coupled to the memory device, the database and the user applications and performs the steps of: allowing the user, via the user application, to establish and maintain the associated virtual space, allowing the user, via the user application, to create and maintain content within the associated virtual space; aggregating the content of the user to Web 2.0 platforms and allowing users to interact with the content on the Web 2.0 platforms; allowing the user, via the user application, to interact with content in the virtual spaces associated with other users; providing, and storing within the user account, engagement points and/or virtual currency as a function of the interaction with the content in the virtual spaces associated with other users; and managing the user's current level as a function of the engagement points and/or virtual currency stored in their account.

In still another embodiment of the present invention, a non-transitory computer-readable medium comprising one or more computer-executable instructions that, when executed by at least one processor of a server system being configured to implement the social network as a Web 3.0platform, is provided. The computer-executable instruction cause the server system to perform the steps of storing a system executing program including computer instructions, in a memory device;

storing user account records and data associated with user virtual spaces in a database; providing user applications, each user application, stored in memory of a user device associated with one of the users; executing the system execution program for each user on a processor of a server system coupled to the memory device, the database and the user applications; and providing user applications, each user application, stored in memory of a user device associated with one of the users. The system executing program is configured to implement the social network as a Web 3.0 platform. Each user account record and each user virtual space being associated with one of the users. Each user account includes a current level, a number of engagement points, and a virtual currency value. The computer-executing instructions further cause the server system to perform the steps of allowing the user, via the user application, to establish and maintain the associated virtual space, allowing the user, via the user application, to create and maintain content within the associated virtual space; aggregating the content of the user to Web 2.0 platforms and allowing users to interact with the content on the Web 2.0 platforms; allowing the user, via the user application, to interact with content in the virtual spaces associated with other users; providing, and storing within the user account, engagement points and/or virtual currency as a function of the interaction with the content in the virtual spaces associated with other users; and managing the user's current level as a function of the engagement points and/or virtual currency stored in their account.

Version 1 of the World Wide Web is now known as Web 1.0. During this stage, websites were read-only web pages with no interactivity. Individuals interested in creating content during this stage require technical skills to build web pages.

The version we are using today is Web 2.0. It has enabled content creators to quickly post and monitor performance metrics on various hosted platforms such as Instagram, Twitter, Meta, and YouTube, to name a few. The objective of these platforms is to provide access to content. As content attracts more users to their platform, these companies monitor and take their users' data, enabling them to create algorithms that will help track what else we might consume.

These companies productize our data and sell it to advertisers to generate revenue.

### BRIEF DESCRIPTION OF THE SEVERAL VIEWS OF THE DRAWINGS

These and other features and advantages of the present invention will become more readily appreciated when considered in connection with the following detailed description and appended drawings.

FIG. 1 is a block diagram of a system for providing a virtual social network.

FIG. 2 is an illustration of a database for use with the system of FIG. 1.

FIG. 3. is an exemplary data file associated with a user account of the system of FIG. 1.

FIG. 4 is a flow diagram of a method associated with the system of FIG. 1.

FIG. 5 is a diagrammatic illustration of a guest account associated with the system of FIG. 1.

FIG. 6 is a diagrammatic illustration of a member account associated with the system of FIG. 1.

FIG. 7 is a diagrammatic illustration of an elite account associated with the system of FIG. 1.

FIG. 8 is a diagrammatic illustration of an influence account associated with the system of FIG. 1.

FIG. 9 is a diagrammatic illustration of a progression between types of user accounts associated with the system of FIG. 1.

FIG. 10 is a diagrammatic illustration related to a token associated with the system of FIG. 1.

FIG. 11 is a first screenshot of a virtual reality environment associated with the system of FIG. 1.

FIG. 12 is a second screenshot of a virtual reality environment associated with the system of FIG. 1.

FIG. 13 is a third screenshot of a virtual reality environment associated with the system of FIG. 1.

FIG. 14 is a fourth screenshot of a virtual reality environment associated with the system of FIG. 1.

FIGS. 15-21 are a diagrammatic illustration associated with the virtual social network of FIG. 1.

### DETAILED DESCRIPTION OF THE INVENTION

With reference to the drawings and in operation, the present invention provides a system 100, a method M100, and non-transitory computer-readable medium for providing a virtual social media network or social network 102 on a social network platform 104. In the illustrated embodiment, the social network is implemented in Web 3.0 technology and is aggregated to Web 2.0 technology to provide access thereto, including the creation, modification, and maintenance of media, across Web 2.0 platforms.

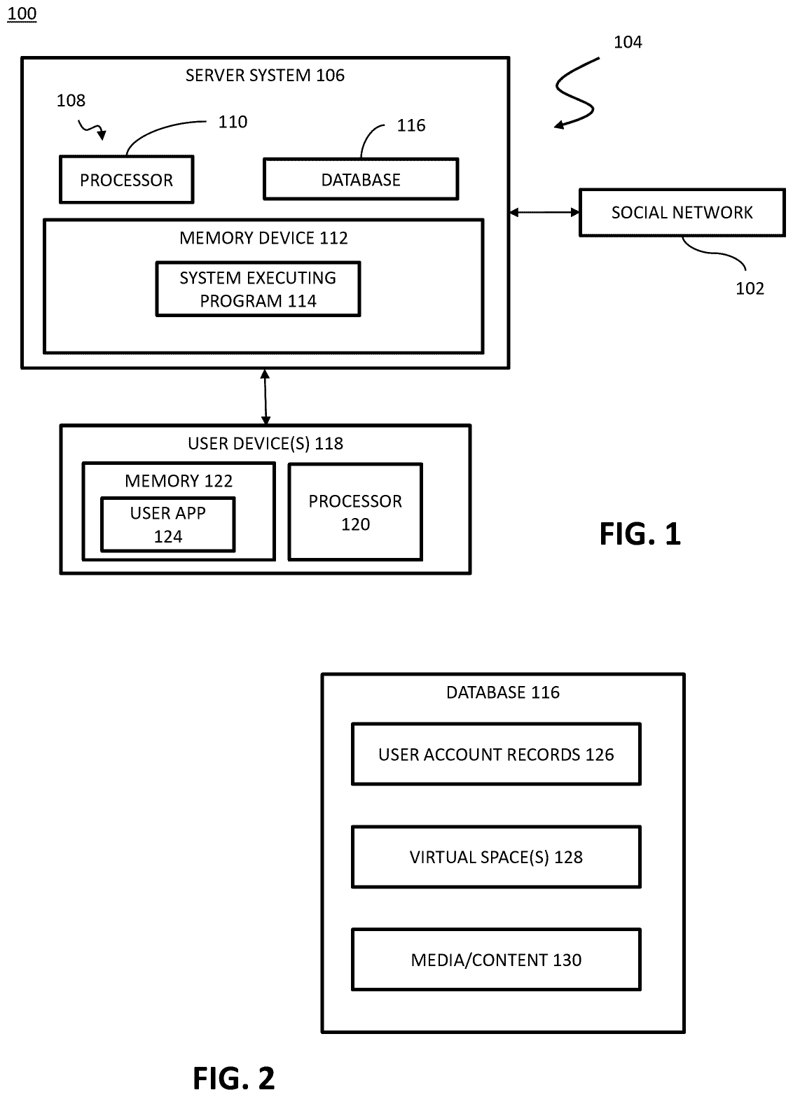

With specific reference to FIG. 1, in the illustrated embodiment, the system 100 may be implemented on a server system 102. The server system 102 may include one or servers 104 and a database 106 managed by the one or more servers 104. The database 106 stores and maintains various records or data files for use by the system 10. The database 106 may be comprised of one or more databases distributed and/or maintained by the one or more servers 104. The system memory device 112 stores one or more pieces of software or system execution program(s) which are used by the server(s) and/or other devices for controlling operation of the system 100, servers 104 and/or other devices of, or associated with, the system 100 or user device(s) 118. The system execution program(s) comprise algorithms, which when run by the various devices, implement respective functions and/or engines of the system 100.

As discussed above, in the illustrated embodiment, the (system) memory device 112 stores a system execution program including computer instructions. The database 116 is coupled to the server(s) 108 for storing data records related to a plurality of users of the system 100 and as well as media/content (see below). The server(s) 108 are coupled to the memory device 112 and the database 116. Each server 108 includes at least one processor 110 programmed to execute the system execution program to establish the social network platform 104 on which the social network 102 operates or is run.

As stated above, in the illustrated embodiment, the system executing program 114 may be stored in the memory device 112. In some embodiment, the memory device 112 may include non-transitory media, such as a programmable ROM memory device or an optical disk. In other embodiments, the memory device 112 may include a disk drive such as a magnetic hard disk drive and a solid-state disk drive. Further, in the illustrated emblement, the system executing program is configured to implement the social network as a Web 3.0 platform.

With reference to FIG. 2, the database 116 may be used to store user account records 126, data associated with user virtual spaces 128 and/or media that is created, referenced, or maintained by users of the system 100. Each user account record 126 and each user virtual space 128 is associated with one of the users. Each user account may include a current level, a number of engagement points, and a virtual currency value associated with the user.

User applications or apps) may be downloaded and stored and/or run on the user devices 118. A user device 118 may include a mobile phone, table, personal computer, laptop computer or other computing device. The user application or app may be stored in memory 122 associated with the user device 118 and may be run or executed by a processor 120 of the user device.

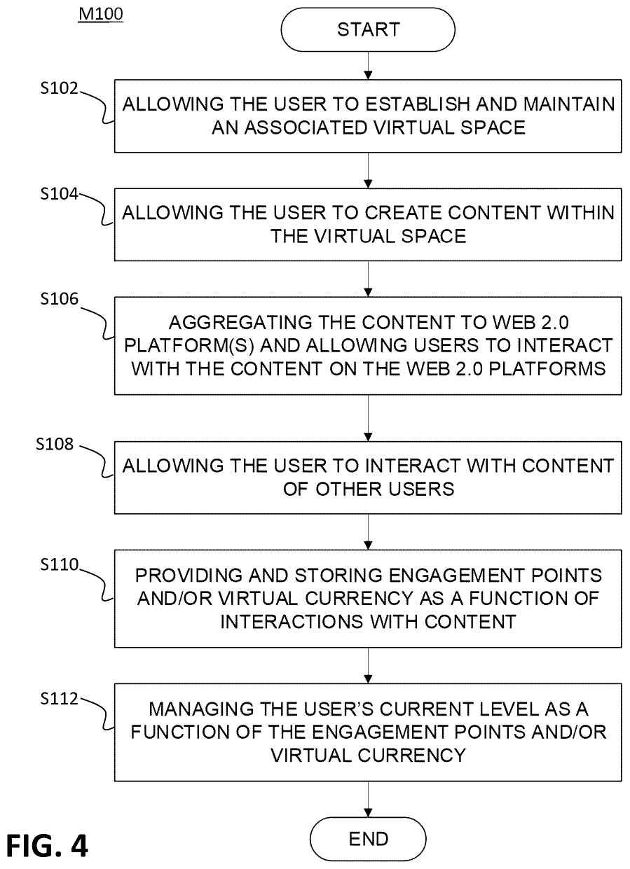

The server system 106 is coupled to the memory device 112, the database 116, and the user applications 124. The server system 106 includes a processor 110 programmed to execute the system execution program 114. With reference to FIG. 4, the system 100 under control of the system execute program 114 performs a method M100 associated with the social network 102.

In a first step S102, a user is allowed, via the user application 124, to establish and maintain the associated virtual space 128 (see below). In a second step S104, the user is allowed, via the user application, to create and maintain content 130 within the associated virtual space 128.

In a third step S106, the content associated with user(s) is aggregated to Web 2.0 platforms. This allows users to interact with the content on the Web 2.0 platforms. In a fourth step S108, the user is allowed, via the user application 124, to interact with content in the virtual spaces 128 associated with other users. In a fifth step S110, engagement points and/or virtual currency are provided and stored within the user account as a function of the interaction with the content in the virtual spaces associated with other users. And in a sixth step S112, the user's current level as a function of the engagement points and/or virtual currency stored in their account.

In one embodiment, each user account may include a virtual wallet for storing the number of engagement points and virtual currency value. Engagement points and/or virtual currency may be purchased with real-world currency. Further, at least some of the content may require payment of engagement points and/or virtual currency to access.

### Industrial Applicability

### History of the World Wide Web

Version 1 of the World Wide Web is now known as Web 1.0. During this stage, websites were read-only web pages with no interactivity. Individuals interested in creating content during this stage require technical skills to build web pages.

The version we are using today is Web 2.0. It has enabled content creators to quickly post and monitor performance metrics on various hosted platforms such as Instagram, Twitter, Meta, and YouTube, to name a few. The objective of these platforms is to provide access to content. As content attracts more users to their platform, these companies monitor and take their users' data, enabling them to create algorithms that will help track what else users might consume. These companies productize and monetize user's data and sell the data to advertisers to generate revenue.

Web 3 is nascent and in the development stages, where developers and creators are currently observing both positive and negative implications of an evolving technology that can allow users to create and moderate spaces for content creators and influencers to promote and augment performances, commerce, and other events.

### The Verse Concept

With reference to FIGS, 5-14, in one embodiment, the invention may be implemented as a social media network known as “Verse Social”. Verse Social is a Web 3.0 social blockchain platform that takes the best things about Patreon, Reddit, Facebook, Instagram, YouTube and Twitter/X, and adds them to a very unique token/crypto/currency-based platform. In its simplest form, using layers of users, which all contribute to making it a top-notch haven for Influencers. Verse Social aims to be the best AI tool on the market for users or influencers to be able to interact with their following on multiple levels. Users will be able to create, curate, and cultivate wildly amazing ways to gather crowds, garner an even larger following, integrate Web 3.0 concepts, and pave the way for the next great social media platform, which has gone stagnant for over a decade.

The Verse Social Club, referred to from now on as (“The Verse”) is a “Web3 based Spatial computing monetized landscape leveraging AI and blockchain to create a fully customizable community, influencer or B2B/B2C-based brand presence.” As a digital landscape, the Verse enables users or “Members” to have ownership of data, presence and content included in the Web3 definition of Read, Write, Own (execute). Members' activity will be community, commerce and socially driven with opportunities for high engagement. Each individual or organization may create their own value, contributing to their status in The Verse. The Verse is a decentralized chain or hub of individual Verses built within a shared Spatial landscape. With admission verification the need for heavy oversight is limited, thereby, eliminating scammers/spammers and bots.

### Vision—Exploring a New Digital Landscape

The present invention, as embodied in the Verse, provides a scenario where the way we access, scale business and online content that is determined not by monopolistic entities but by individual users. While the Web3 core infrastructure remains unchanged and is made better by AI technology.

### Embarking on an Uncharted Journey

The Verse is a virtual hub structure or decentralized chain of Verses where people can Connect, Create, Publish and Optimize Revenue. The greater vision is to create an environment where people can come together through common interests, where interaction can be established through conversation, sharing of content and ecommerce to build partnerships, business propositions and for individuals to build and connect over real life conversations or in IRL events. The Verse can be the ground zero mechanism that brings all of these areas together with the potential to grow into something much greater, which members have a voice in shaping.

### Focus

Making The Verse a reliable, easy to use and secure Web3 digital landscape.

Cultivating a Strong Social Hub—We want to have members engage in all areas of interest with safe spaces to discuss, create content, conduct commerce, and participate.

Empowering Verse Community/Members—We recognize our responsibility to listen, provide tools and opportunities and support the needs of the members.

Enabling secure data activities and transactions.

Promoting ecommerce for content creators, businesses, educational institutions, and government identities.

The Verse is based on the premise that Influencers should own their own social networks, the content that they create, and that the earnings should go into their pockets. Verse would help with the following:
Creating a platform that is reliable, dependable, easy to use, customizable and works for all of their needs.
The value created by users is all their own.
Monetization begins immediately and goes directly to them.
Alleviate the fear of being deplatformed, losing that direct link to their users.
Alleviate fears of having their content being taken down or censored.

The Verse intends to revolutionize the social networking experience by providing.
Opportunity and ownership to Members & VIPs in various ways:
Creating a platform that enables Members to work their way up, gain status, and be a part of something bigger.
Allows users to use their networks in powerful ways and aid with ecommerce, branding and connecting; like Influencers, opening doors.
A token-based membership with Web3 capabilities that confer rights to identity, ownership, privacy, and security.
Provides all users with an exclusive monetary interest transferable on the blockchain.

### Verse Differentiators

The Verse or Verse Social Club revolutionizes the social networking experience by giving ownership of their social graph and content, by allowing users to connect, build and monetize. The Verse is an interactive platform with an encrypted access ecosystem built on the blockchain.

The Verse Social Club, referred to from now on as (“The Verse”) is a “Web3 based Spatial computing monetized landscape leveraging AI and blockchain to create a fully customizable community, influencer or B2B/B2C-based brand presence.” As a digital landscape, the Verse enables Members to have ownership of data, presence and content included in the Web3 definition of Read, Write, Own (execute). Members activity will be community, commerce and socially driven with opportunities for high engagement. Each individual or organization will create their own value, contributing to their status in The Verse. The Verse will be a decentralized chain or hub of individual Verses built within a shared Spatial landscape. With admission verification we limit the need for heavy oversight, eliminating scammers/spammers and bots.

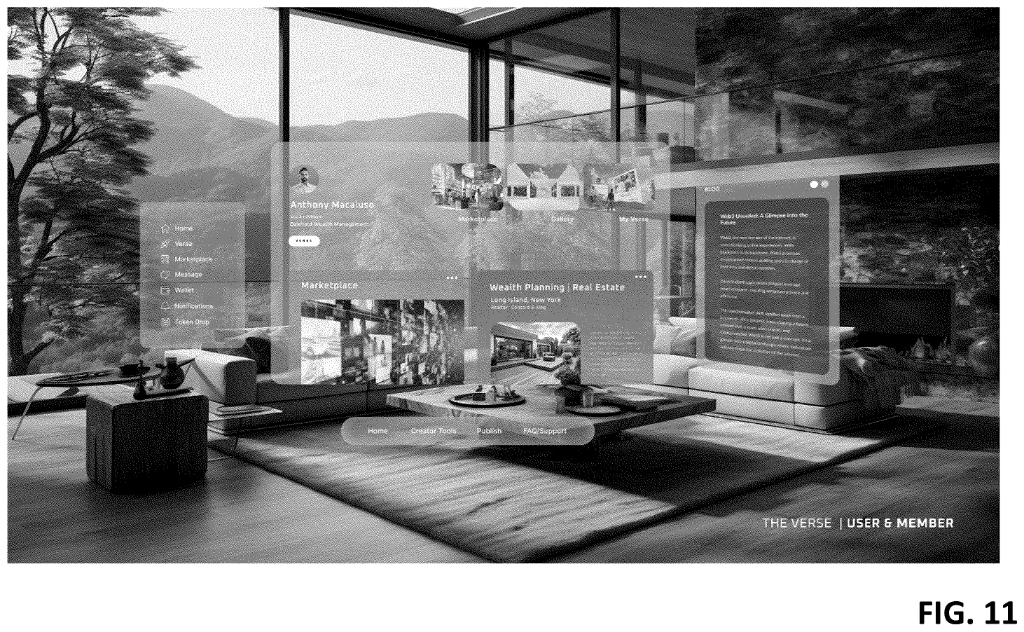

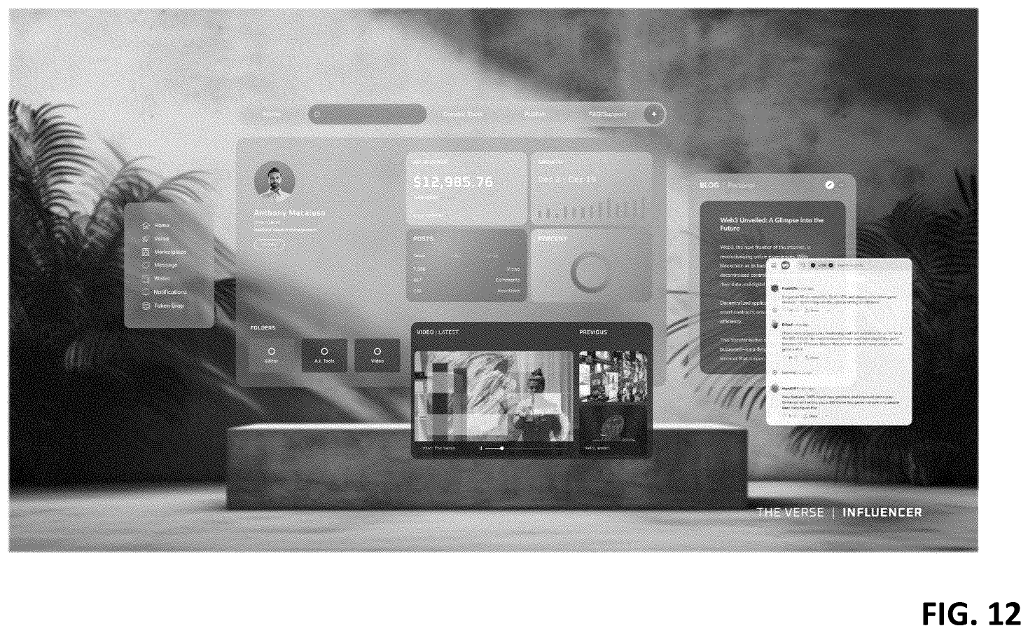

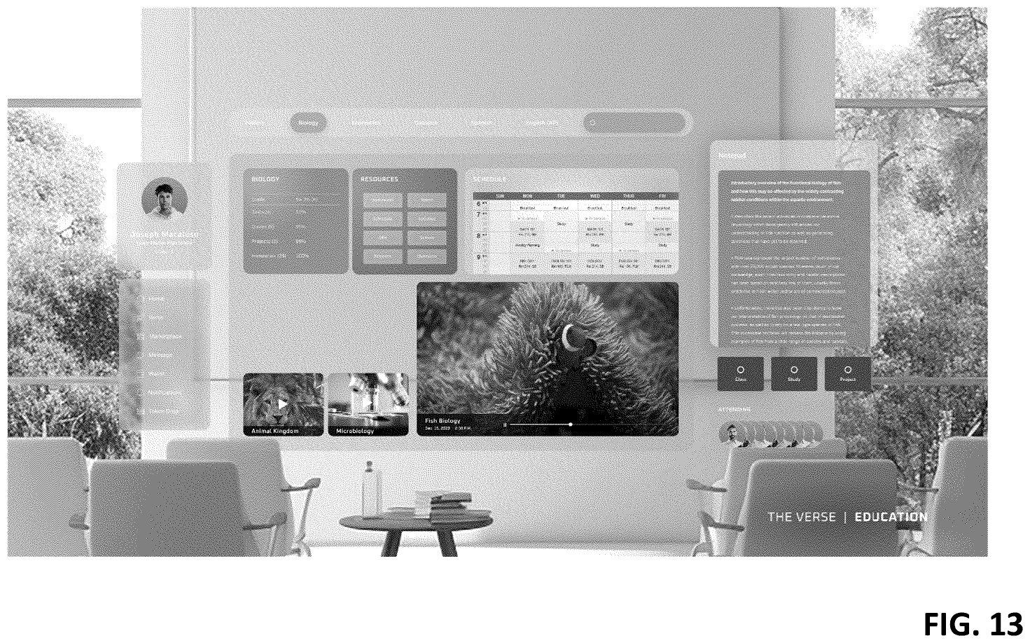

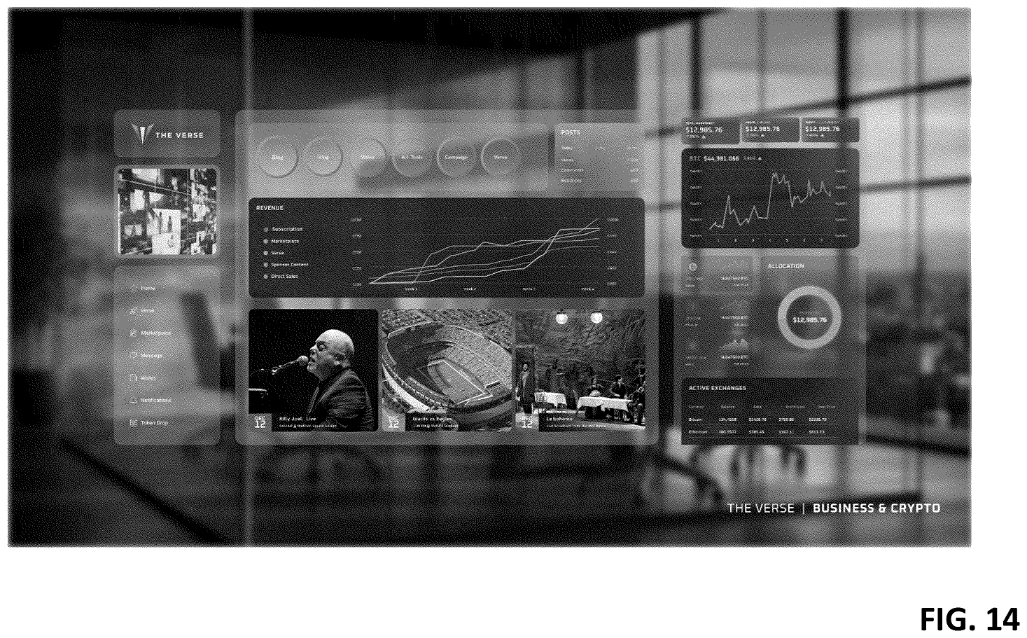

In simplest terms: The Verse is an environment that sits on the internet using Web3 tools and tech, providing an individual or business a way to build communities (Reddit/Facebook), conduct business transactions(websites) link those transactions and events “In Real Life” (IRL) via QR codes assigned to the blockchain ledger account by person or business. Transactions can be done with multiple currencies and with converted crypto via Fiat. The Verse interface or user experience is built in Spatial computing, POV via VR, mobile, laptop (see FIGS. 11-14). Easy to use and flexible to create as a “content creator” can blog/vlog/video, edit those with AI tools provided by the Verse or of their choice. The Verse eliminates using and managing the individual platforms by merging multiple platform input into one customizable digital landscape, aggregating to Web2.

The Verse is a “Web3 technology based, Spatial computing, monetized, landscape. leveraging AI and blockchain to create a fully customizable community, influencer or B2B/B2C-based brand presence.”

The Verse provides a Spatial, blockchain solution with zero knowledge proofs security and data control. AI tools provide assistance in content creation, data analysis and revenue growth. Imagine a scenario where the way content is accessed, business scaled and online content that is determined not by monopolistic entities but by individual users. While the Web3 core infrastructure remains unchanged and is made better by AI technology.

### Aggregation to Web2 (2.0)

The Verse allows members to build and to entice engagement of individuals, businesses and influencers using integrated AI and API tools that aggregate content and ecommerce events and experiences. Examples include building a Verse, creating a Vlog and using our tools, posting that Vlog out onto Web2 platforms with requests to engage being directed back to The Verse.

The Verse provides a way for Content Creators (Influencers, business, etc.) to create content in one space with ideal tools. Editing features and upload will be done via us out to Web2 platforms, eliminating time and API issues. (Facebook, YouTube, Snapchat, X (if it is still alive), Instagram, TikTok) all allow API integration.

The Verse further provides each user the ability to build their Verse with full access to their brand, ecommerce and social media/fintech activities in one space, instead of 5 or 6 separate platforms.

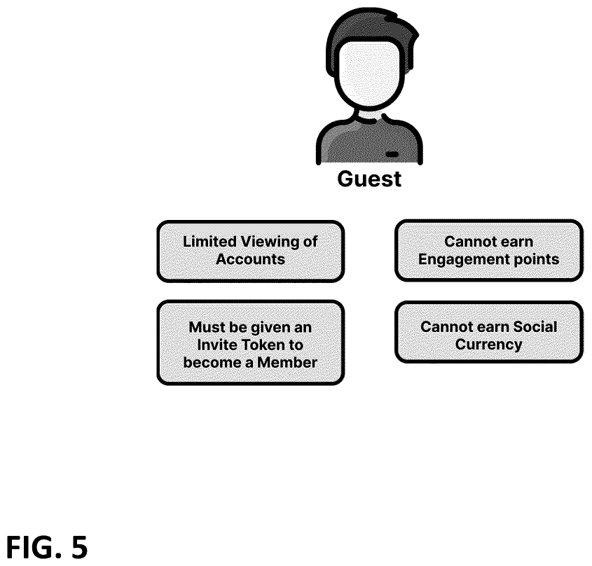

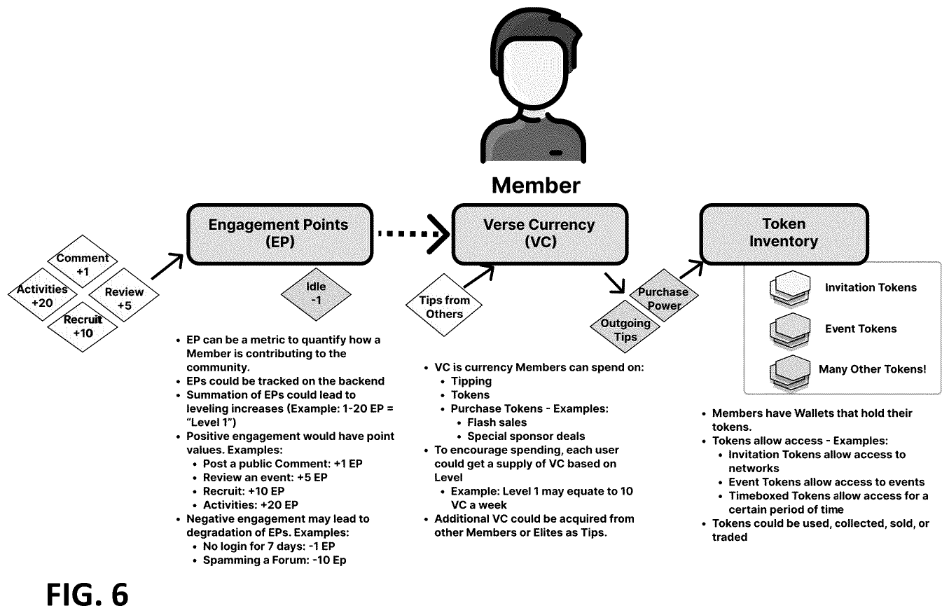

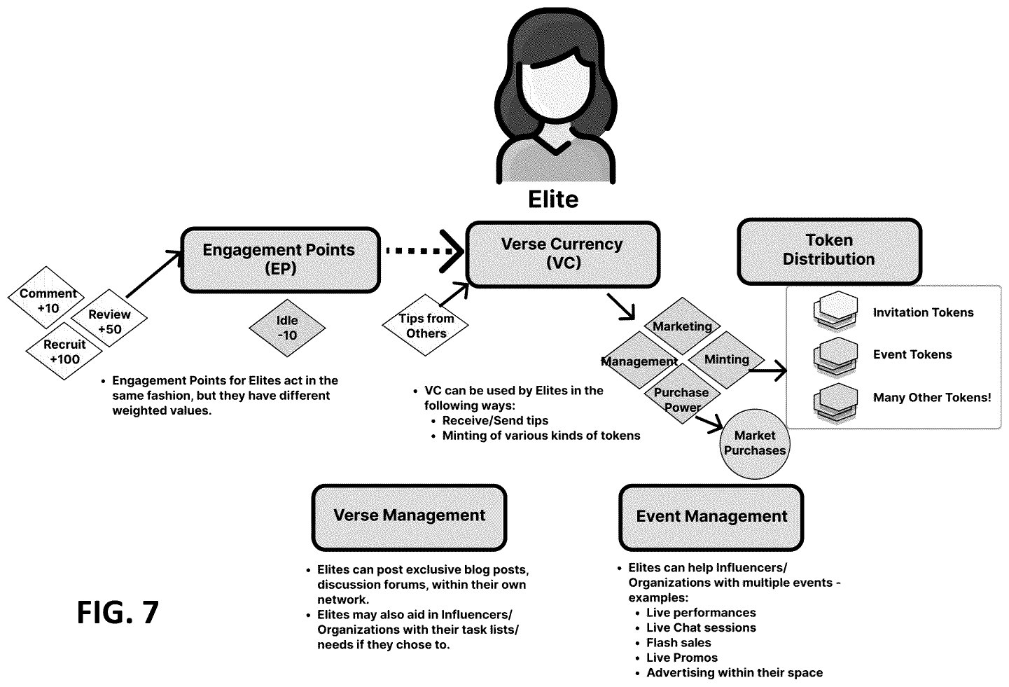

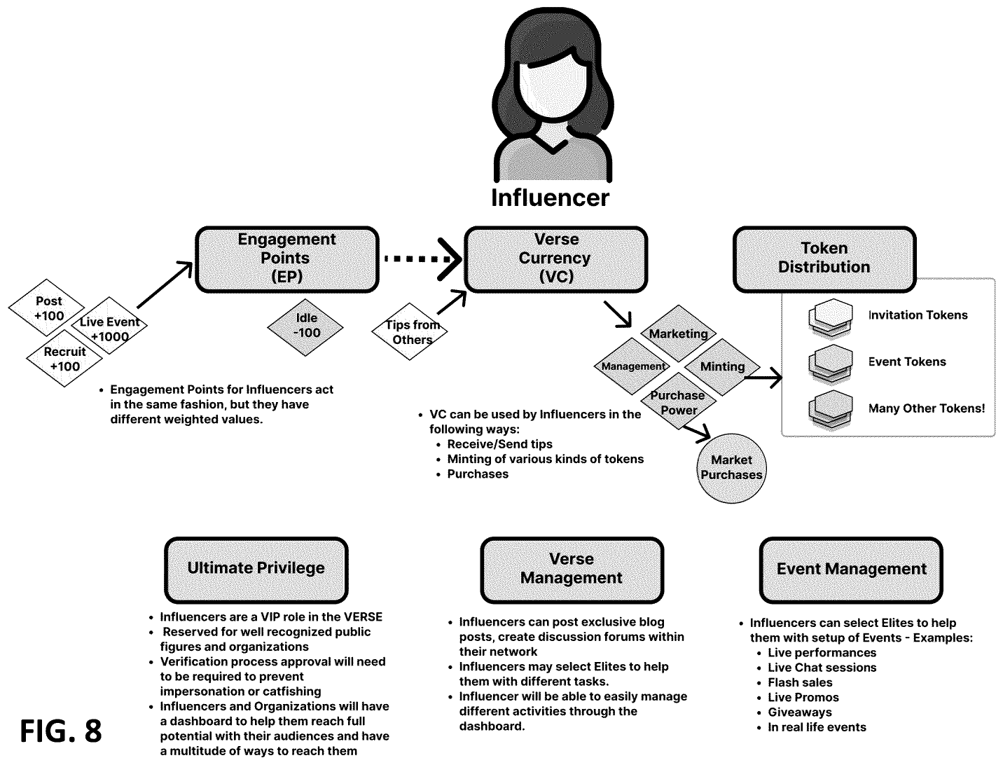

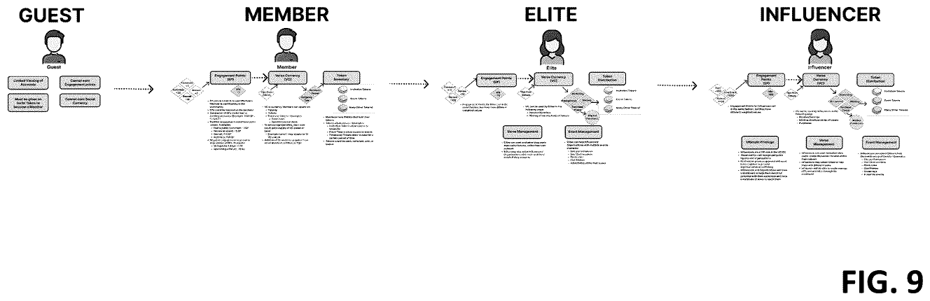

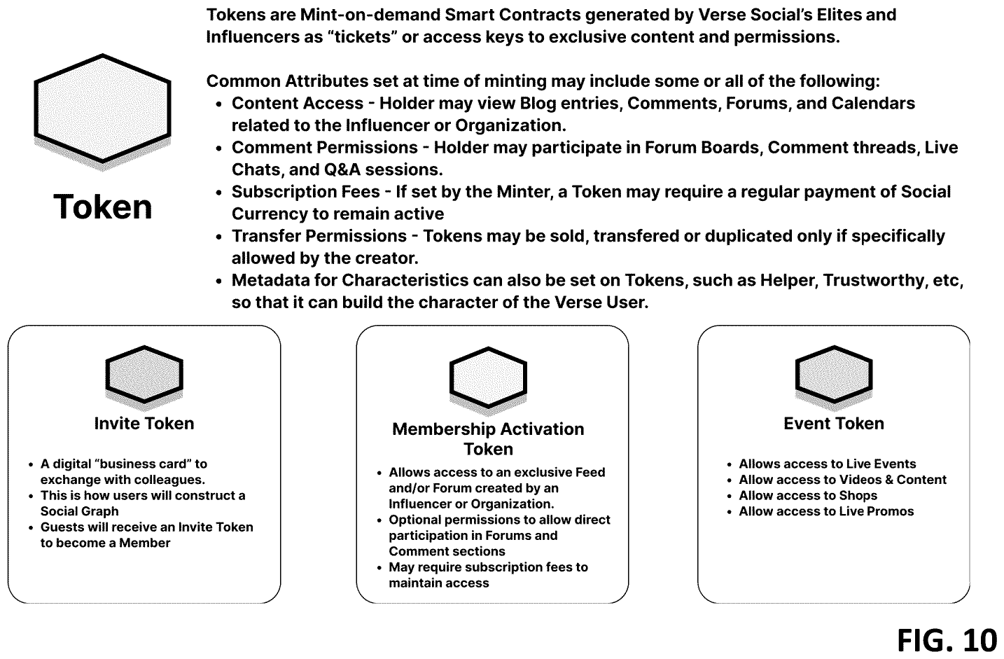

In the illustrated embodiment, users may have one of the following types of roles: Guests, Members, VIP, Influencers and Businesses/Organizations (see FIGS. 5-9). Verses

Verses are the Verse Social Club's user spaces. A User's Verse could be customized for their role. Theme can pertain to the name or the background or the content that is posted. A Verse has its own content not limited to but usually related to that Influencer or Organization. Examples include, but are not limited to:
Blog entries,
Videos
Pictures
Audio
Forums
Polls
Q&A sessions
Comment sections
Activities for Engagement Points
Sponsored Advertisements
Events

Tokens may be required to access or participate in some or all of this content.

### Events

Events are activities/happenings that an Influencer can invite Members to. They may be planned events, or they may be completely spontaneous, virtual or in real life. Ecommerce should be able to be attached to any Event. Events may include but are not limited to:
Hosting a discussion via Text/Chat/Vid,
Hosting Real Life Meetups,
Hosting Social Events,
Hosting a spontaneous or planned music concert,
Hosting a spontaneous interview,
Easter Egg events (Pop up stores/surprise concerts-anything surprise and delight),
Sponsor/Brand events,
Partnership events with another Sponsor,
Partnership events with another Influencer,
Flash Sales,
Partnering with Brands,
Showcasing Merch for a special Promo,
Behind the scenes footage before shows,
Backstage access,
Special Topics picked by Members,
Virtual or in Real Life Demonstrations,
Unboxing/Unveiling new merchandise,
Timeboxed Giveaways,
Timeboxed Offers,
Streamed Tours through Museums, Observatories,
Talks,
Seminars,
Virtual Book Clubs,
In Real Life Happy Hours,
In Real Life Parties,
Interviews,
Winning signed merchandise,
Raffles (concert tickets, movie premiere tickets, private shopping trips),
Whiteboard demos, and,
Community do good activities.

Verse Currency/Crypto/USD etc. or Token invites could be used for any of the above, dependent upon the criteria that the creator wants.

### Guests

The most basic access to Verse Social is a Guest. They do not have an account/wallet. They can only preview. They may convert to a member through scoring an invite token and setting up an account/wallet.

### Member Role & Profile

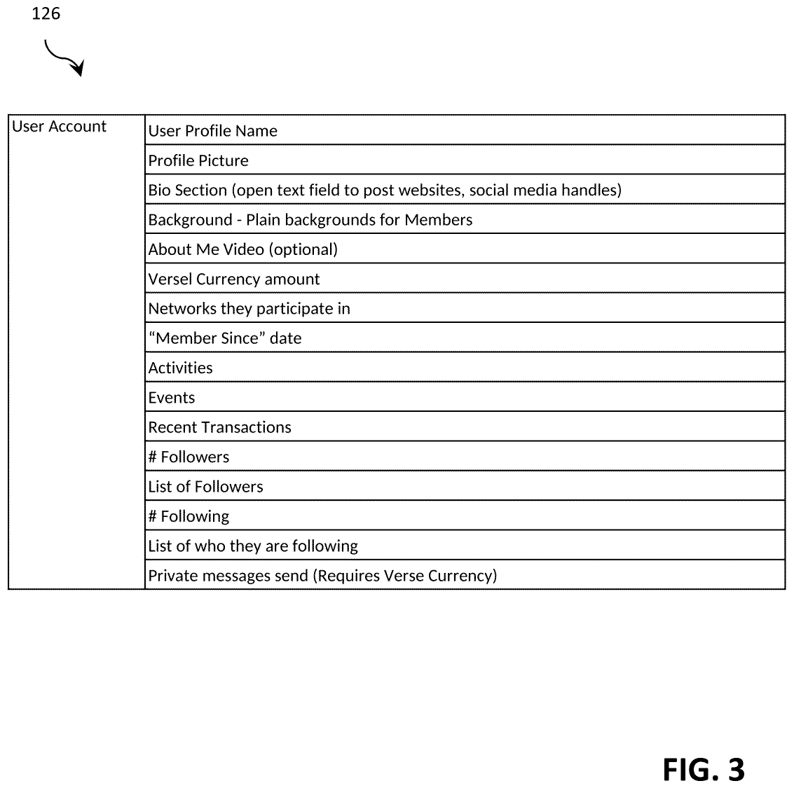

A Member is the next level up from a Guest. Members have received a token which entitles them to become a part of the Invitee's Verse. Members will have a Wallet. They will have a dashboard that will show them a multitude of items. Suggestions on what may be displayed on a Member Profile of their Verse (see FIG. 3):
User Profile Name
Profile Picture
Bio Section (open text field to post websites, social media handles)
Background—Plain backgrounds for Members
About Me Video (optional)
Versel Currency amount
Networks they participate in
“Member Since” date
Activities
Events
Recent Transactions
#Followers
List of Followers
#Following
List of who they are following, and
Private messages send (Requires Verse Currency).

### VIP Role & Profile

VIPs are the next tier of users up from a member. VIP must have a Wallet. Each VIP member could also set up their own individual “Verse”—a place that acts as their central hotspot that encompasses activities, chat, search, announcements, etc. In their Verse, there could be open chat on hot topics, debates, polls, upvoting future topics, private pop-up stores, flash sales that take Verse Currency, as well as individual and Group events inside the Verse or In Real Life (IRL). Most importantly, the Verse provides a VIP with the ability to deepen their relationship with their participants by creating a lot of engagement opportunities. Some VIP may choose to monetize their Verse by including Sponsors/Advertisers full time and allowing those Advertisers to sell items. VIPs have the opportunity to become Influencers and use that exposure to maximize their footprint and expand their content, brand, and monetization.

Suggestions on what may be displayed in a VIP Profile section. Example is similar to the individual member profile shown:
User Profile Name,
Profile Picture,
Bio Section (Open text field/AI Tools and API links to post websites, social media handles),
Background-Textured backgrounds for Elites ($$),
About Me video (optional, but recommended),
Versel Currency amount,
Networks created,
Networks joined,
“Member Since” Date,
Events they will host,
Recent Transactions,
#Followers,
List of Followers,
#they are Following,
List of who they are following, and
Private messages send (Requires Verse Currency).

### Influencer/Organization Roles & Profiles

An Influencer or Organization these are the big players who will bring the critical mass to the Verse, one person at a time. They will have an entire platform that will be their playground—tailored and built for ease of use to blog, vlog, stream live events, create real life events, notifications, and host swag giveaways. Influencers can generate and distribute tokens that allow access to exclusive areas and events.

### Token Drop

The other enticing point is that influencers or organizations can mint and sell tokens, creating revenue for them and their followers, as well as royalties. It will be the most reliable, dependable, tool on the market to allow for maximum engagement with their followers. They will have access to the “Deluxe Dashboard” for their profile and must have their wallet created. Suggestions on what may be displayed in an Influencer Profile section:
Real Life Stage Name/Organization Name,
Profile Picture,
Bio Section (Open text field to post websites, social media handles),
Background-Custom backgrounds available for Influencers only ($$$$),
About Me video (optional, but HIGHLY recommended),
Verse Currency amount,
Networks created,
Networks joined,
“Member Since” Date,
Events they are appearing in,
Recent Transactions,
Collaborations with Sponsors,
#Followers,
List of Followers,
#they are Following, and,
List of who they are following.

Example of Influencers:
Writers,
Singers,
Actors/Actresses,
Athletes, and,
Social Media Star.

Example Organizations:
Sports teams,
Concert Organizations,
Museums,
Industry Groups,
Universities, and
High Schools.

### Business

Business can range from small businesses to large corporations of any kind that want a part of this unique community. The concept will be attractive because businesses are always looking for fresh and exciting ways to expand their reach. Where some platforms are picking and choosing who will be on their platform, this can be sold as a non-discriminating environment where all are welcome. The Business will have its own role within Verse and in order to keep this role as a business mechanism, the business itself will have to buy in, whether that be a monthly, bi-annual, or yearly subscription/token.

Business could work with anyone to advertise, link to Promos, and promote special happenings for Influencers. For Influencers, their role could be much larger in working with businesses with Unboxings, Unveilings, Live Promos, Demos, Contents, and Giveaways. The Business Role will be unique in the sense that Influencers are going to want to see who will bring them the most revenue, who will work with them regularly, who has the most innovative and engaging ideas. Business will have the opportunity to study their Influencer's followers, based on capturing data points to be able to create campaigns specifically to target certain demographics, and figure out ways to entice those users. It will definitely be a unique advertising opportunity.

They will have tools available to be able to create innovative ways to showcase their products or line of business to the audience. AI tools will be available to manage their data and interactions with other Verses, with secure protocols and permissions. They will want to engage with Influencers that have high numbers of followers to get the most impactful footprints. Influencers and VIPs may just choose to work with certain reputable businesses and brands because they are fans of the products or services.

### Verse Wallet/Currency/Exchange

Access web3 services and hold digital assets without needing to manually download a crypto wallet. Seamlessly interact within our Marketplace, IRL experiences, and enjoy frictionless web3 onboarding with the scan of a QR code.

Transact with any customer through Fiat Money; fill your embedded wallet with currency of choice: USD, GBP, Euro or Crypto.

In the era of data breaches and privacy concerns, Wallet ID ensures secure transactions but also enables a personalized shopping experience for each customer.

A Wallet ID serves as a unique identifier within the digital world, offering a secure and personalized means to interact with online platforms. Built upon blockchain and Web3 technology, Wallet IDs are quickly becoming integral for online transactions, especially in the retail sector. Let's examine some key features of a Wallet ID.

Integrating Wallet ID technology into retail activations offers customers a secure, streamlined shopping experience. The implementation can lead to a 50% reduction in transaction fraud and at least a 30% increase in customer retention rate. Customers can safely store their purchase history, personal information, and preferences, promoting a seamless transition between online and offline shopping.

### Non-Fungible Tokens (NFTs)

NFTs are non-fungible tokens that are unique digital assets. The Verse uses NFTs as an asset listed on the blockchain/ledger showing value and ownership. These can be exchanged or transferred to another owner with a wallet exchange and separation from the ledger/account QR code. Tokens may be persistent, timeboxed, or used for a set number of uses. They may require a fee or subscription to keep them active. NFTs may be transferred to other Members, may be transferable with restrictions or nontransferable. NFTs can be embedded with Metadata characteristics so that a member can be identified and linked to their account/QR code.

### Real Life Tokens (RLT)/In Real Life Events

The Verse has Phygital tokens. A Phygital is the concept of using technology to bridge the digital world with the physical world with the purpose of providing a unique interactive experience for the user.

### Unique Digital Identity

Each Phygital NFT carries a distinct digital identity. This identity is immutable and secure, stored on the blockchain, effectively tying the physical asset to its digital representation. This offers a layer of transparency and authenticity that traditional digital representations lack. Phygital are more than just digital replicas of physical products—they are an emphatic statement by businesses to demonstrate the enduring value and authenticity of their offerings.

Phygital NFTs offer an interactive experience. In retail activations, for instance, customers can engage with the digital representation of a product in ways that may not be feasible with the physical product, such as viewing it from various angles or ‘trying it on’ virtually.

Every Phygital Twin encapsulates assets that symbolize systems, products or services, and even business processes—virtually anything that can be digitally modeled using virtual reality or 3D modeling technology. This linkage opens up a myriad of possibilities for enhancing customer engagement. It also adds a layer of trust, knowing that the digital representation is a true reflection of the physical product.

### Immutable Ownership

Since Phygital NFTs are stored on a blockchain, the ownership records are immutable and transparent. This creates a secure environment for customers, as they can verify the chain of ownership and authenticity of the product.

### Enhanced Security in Retail Activations

Phygital NFTs offer enhanced security. The integration of NFTs with Wallet ID adds a layer of security, as each transaction and interaction with the NFT is tracked and verified, reducing the risk of fraud.

### Real-World Utility

While some NFTs are purely digital with no real-world equivalent, Phygital Twins NFTs are directly linked to a physical item or product. This offers additional utility, as the ownership of the NFT can equate to the ownership of the physical item.

### Novelty and Exclusivity

Finally, the nature of NFTs offers a sense of novelty and exclusivity. Owning a Phygital Twin NFT isn't just about owning a piece of digital art or a digital representation of a product—it's about owning a unique piece of the physical and digital universe.

Physical tokens are linked to a QR code which any member who owns a wallet can access to buy, sell or activate to attend In Verse Events or IRL In Real Life events. The QR code will be separated from the token if it is sold or exchanged.

The Verse Tokens were created by an artist specifically with the Verse in mind, using the curated Verse Social Club logo. A 3D printing or minting of this token could be used as an extension of the digital concept, bringing validity to the Verse in real life events that a member may want to partake in, and get credit for. Also, it would help prove the exclusivity and perks that only members enjoy. Each member who wants to use the Real-Life Tokens (RLT) must sign up to be issued. Verse application will also be mapped to a QR code that will be displayed on the back of their printed or minted RLT. The vendor holding events must have a QR code reader so that the QR code can be scanned. The member's event will be captured in the backend, so that they can receive the credit for attending. To add extra safeguards for the event, once the QR code is scanned, the member will receive a notification in the Verse Social app that they can show the door person that it was received and then they may gain entry, but only until that notification is received in the app. So, members can pull out their token, flip it over, scan it, get confirmation, and be in.

### Spatial Computing-Templating/Verses

Spatial computing is a technology that enables computers to blend in with the physical world in a natural way. It relies on several technologies to mix the digital and physical worlds.

They use computer vision, which processes data from cameras and other sensors and captures visual information about the environment, including the position, orientation, and movement of objects. With sensor fusion, they can combine data from multiple sensors, such as cameras and LiDARs , to create an accurate and comprehensive view of the environment. And they use spatial mapping to create a 3D model of the environment, which allows for more precise placement and manipulation of digital content.

Spatial mapping is what is shown in the examples (FIGS. 11-14). This is a very different engagement vs. the current scrolling apps approach but, will be just as engaging if not more so. POV can be singular person or “view from above” as if you were using a VR headset, as example, Apple Vision pro. You do not need a VR headset to use The Verse and we do not recommend that young adults under 28 years of age use one.

Users will have a choice of preformatted templates created in Spatial or creating their own based on the flexibility and options available. We will provide several templates for selection at entry level, options for low-income users and customize templates for businesses and influencers on a fee basis. We also will provide select contractors which will create specialized Verses that are approved by The Verse.

### Monetization

Monetization Strategy includes subscription-based membership, token drop by business or influencer, advertising revenue and sponsored content.

### Recurring Transaction Revenue:

Core Revenue 30% of each transaction (60/30/10)

### Crypto Currency Exchange Fees

Marketplace, Individual Spaces and Core, CPM Ad Revenue charge $10 (per 1,000 views/impressions)

### Token Exchange 20% Royalty

### Single Occurrence Revenue—Subscriptions

Individual sliding scale flat fee for entry membership based on verification of income.

Corporate sliding scale flat fee for entry membership based on valuation and profitability valued from $1000 to unlimited.

### Token Drop

A Token is a QRcode/validated coded entry to a company, influencer or business's Verse with rights to exclusive IRL events, content. (Given The Average Token price of $5.00 per subscription)×(25% of 1M followers)×(1% of users with>1M followers)

The Verse also offers physical Tokens for purchase for VIP Members or those wanting to include them in their SWAG, as a Luxury Brand might do.

Marketplace—General Ads—Single placement or Campaign Revenue for placement.

In Verse/Room Ad placement—Single placement with permission of owner of room/verse and agreement with owner/room.

Advertising—Core Community (Reddit/Facebook configured Area)—Single placement and agreement with moderators, beyond CPM.

### Wallet ID to enable Personalized and Secure Shopping Experiences

In the era of data breaches and privacy concerns, Wallet ID emerges as a knight in shining armor. It not only ensures secure transactions but also enables a personalized shopping experience for each customer.

A Wallet ID serves as a unique identifier within the digital world, offering a secure and personalized means to interact with online platforms. Built upon blockchain and Web3 technology, Wallet IDs are quickly becoming integral for online transactions, especially in the retail sector.

Integrating Wallet ID technology into retail activations offers customers a secure, streamlined shopping experience. The implementation can lead to a 50% reduction in transaction fraud and at least a 30% increase in customer retention rate. Customers can safely store their purchase history, personal information, and preferences, promoting a seamless transition between online and offline shopping.

### Unique Identification

Just as every individual has a unique identity, every Wallet ID is unique. This helps to distinguish between users, ensuring that all transactions and interactions are accurately attributed to the right user.

### Security and Data Privacy

Wallet IDs provide an enhanced level of security. They leverage the robust security protocols of blockchain technology to provide a secure platform for transactions. This helps to mitigate the risks of fraud, identity theft, and other security concerns that are common in the digital space.

It provides a mechanism to maintain user privacy. Rather than sharing personal information directly with online services, users interact with them through their Wallet ID. This offers a level of data privacy that isn't typically available with traditional online transactions.

### Seamless Transactions in Retail Activations

Wallet IDs streamline the transaction process. They can be used to store digital assets, enabling fast and easy transactions. Whether purchasing products online, interacting with digital services, or engaging in other online activities, Wallet IDs provide a seamless user experience.

### Consistent Activity Across All Channels

Consistent branding across all channels helps to solidify your brand identity in the minds of your customers. From your physical stores to your digital platforms, ensure your branding is consistent and recognizable. This consistency should extend to the experiences offered by Phygital and Wallet ID.

### Personalized Experience

By tying a Wallet ID to a user's preferences and behaviors, businesses can offer a personalized experience. This can range from product recommendations to personalized discounts, all tailored to the user's unique tastes and shopping habits.

### Cross-Platform Usability

Wallet IDs are not limited to a single platform or service. They can be used across various platforms that accept Web3 transactions, offering users a consistent and seamless experience across multiple services.

### Ownership of Digital Assets in Retail Activations

With Wallet ID, users can have ownership of digital assets. This is particularly important in the world of non-fungible tokens (NFTs), where ownership of unique digital assets can be tied to a specific Wallet ID.

### Why Do Your Brand Need to Merge Online and Offline Shopping with Phygital and Wallet ID for Retail Activations?

The retail landscape is no longer a battleground of online versus offline, but rather a symbiotic ecosystem where the two converge. Merging online and offline shopping through the use of Phygital and Wallet ID in retail activations is transforming the customer shopping journey. By combining security, personalization, and interactivity of these technologies, your brand can deliver a seamless shopping experience that truly bridges the digital and physical worlds.

### Drive Traffic to Your Offline Stores

The implementation of Phygital and Wallet ID in your retail activations can serve as a powerful magnet, drawing customers to your physical stores. By offering exclusive experiences or incentives tied to your physical location, you can convert digital engagement into physical footfall, increasing offline sales and building stronger customer relationships.

### Merge Online and Offline by Allowing Users to Win a Physical Prize

Phygitals allow customers to engage with your products in a new and exciting way.

Creating digital representations of your physical products gives customers the freedom to explore, interact, and ‘try’ products in a way that was previously unimaginable. This can lead to increased online engagement, higher conversion rates, and lower return rates.

### Capture Wallet ID on the Spot by Offering Potential Future Perks

Wallet IDs offer a wealth of opportunities for personalization and loyalty rewards. By capturing Wallet IDs during retail activations, you can offer future perks such as airdrops, early product access, elite membership to a club, and more. This strategy allows you to reward customer loyalty and keep them engaged with your brand. Moreover, showcasing ownership of a unique NFT through a QR code mechanism provides customers with a sense of exclusivity and privilege, further enhancing their relationship with your brand.

### Zero Knowledge Protocol

Zero Knowledge Protocol (or Zero Knowledge Password Proof, ZKP) is a way of doing authentication where no passwords are exchanged, which means they cannot be stolen. This is cool because it makes your communication so secure and protected that nobody else can find out what you're communicating about or what files you are sharing with each other.

ZKP allows you to prove that you know some secret (or many secrets) to somebody at the other “end” of communication without actually revealing it. The very term “zero knowledge” originates from the fact that no (“zero”) information about the secret is revealed, but the second party (called “Verifier”) is (rightfully) convinced that the first party (called “Prover”) knows the secret in question. Why would you need to prove you know the secret without telling it? When you don't trust the other person, but still need to persuade them that you know it.

In Summary, The Verse is a multi-modal web3 aggregator created to bridge Web2 users and content creators to a new, decentralized digital experience.

The Verse is a digital landscape in Web3 with the potential to be an ecommerce, social media and disruptive technology environment that can support and eliminate the Web2 environment which no longer serves a majority of the world's users in 2024. This would be both a desktop, tablet and a mobile application. From a marketing and monetization prospective It has the perfect model to be a sticky application-something that attracts and retains users.

In simplest terms: We are an environment that sits on the internet using Web3 tools and tech, providing an individual or business a way to build communities (Reddit/Facebook), conduct business transactions(websites) link those transactions and events “In Real Life” (IRL) via QR codes assigned to the blockchain ledger account by person or business. Transactions can be done with multiple currencies and with converted crypto via Fiat. Our interface or user experience is built in Spatial computing, POV via VR, mobile, laptop. Easy to use and flexible to create as a “content creator” can blog/vlog/video, edit those with AI tools we have created or of their choice. We eliminate using and managing the individual platforms by merging multiple platform input into one customizable digital landscape, aggregating to Web2.

We are a “Web3 technology based, Spatial computing, monetized, landscape. leveraging AI and blockchain to create a fully customizable community, influencer or B2B/B2C-based brand presence.”

### Spatial Computing

Spatial computing brings together the virtual and physical worlds in a seamless way. Spatial Computing may be experienced, for example, through headsets such as the Apple Vision Pro and Magic Leap or directly from your mobile devise or laptop/desktop computer. This method, with or without the devices, display the real world and, at the same time, embed real objects into the scene in a way that appears three-dimensional.

These devices and the software on a server rely on several technologies to mix the digital and physical worlds. They use computer vision, which processes data from cameras and other sensors and captures visual information about the environment, including the position, orientation, and movement of objects. With sensor fusion, they can combine data from multiple sensors, such as cameras and LiDARs, to create an accurate and comprehensive view of the environment. And they use spatial mapping to create a 3D model of the environment, which allows for more precise placement and manipulation of digital content.

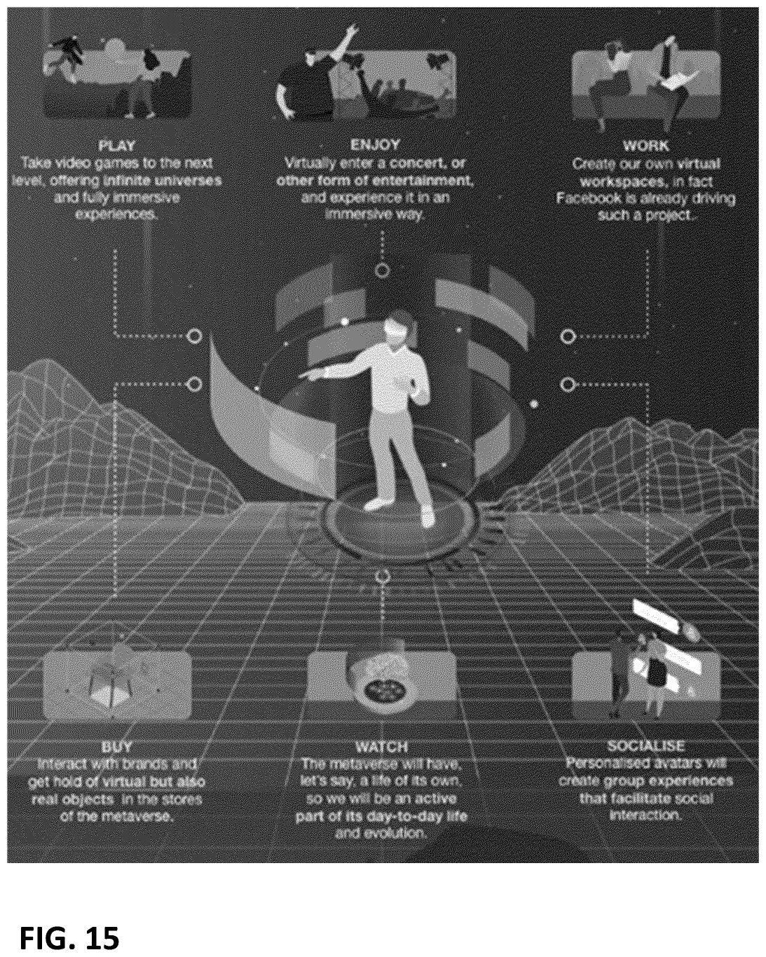

Spatial computing may be a generalized term that refers to systems that extend the input/output layer to physical objects (other than the standard set of peripherals {Web2}) in the real world. There's a bit of overlap with VR and AR, but not nearly enough for any to be considered a subset of the other. Spatial computing refers to the processes and tools used to capture, process, and interact with 3D data. It has become an important computing technology for geographically related applications and services, such as location identification within a graphic layer, spatial planning within the application layer, traffic congestion control, evacuation systems, crowd management, and spatial crowdsourcing, all within the storage and application layers. Spatial computing enables the construction of geographical websites' profiles and services, and it plays a vital role in various fields including medical science, industry, automation, and everyday life. Techniques in spatial computing involve traversing data structures to determine if a location is within a land area, based on indexes and levels (see FIG. 15).

Overall, spatial computing provides innovative solutions for understanding and solving complex problems in a dynamic and interactive manner.

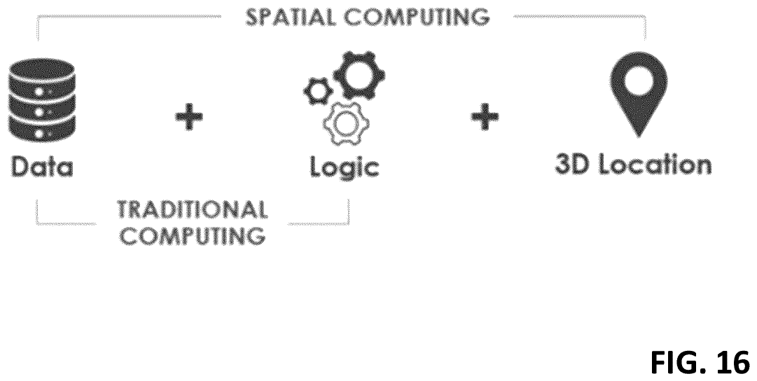

The Verse uses Spatial Computing to provide an environment and UI/UX software to generate a user experience for communication, community events, marketplace activities, content creation and extraction of data to forward to Web2 platforms for brand or communication activities. Spatial Computing is a layered environment (see FIG. 16).

To ensure that spatial computing works as desired, specialized software and hardware are required. Listed below are general components/applications included with the Verse to create the Spatial Computing environment:
3D engines for displaying geometry and animation (for example, Unity—a real time development platform and Unreal Engine—a real time 3D creation tools),
Geospatial mapping and object recognition for mapping and analyzing the real and virtual worlds,
Gesture and voice recognition,
Internet of Things for data integration from device (Networking software to engage between devices. Today this software is used to link your phone to your NEST thermostat.),
Blockchain open-source software to manage data and account information within the interoperability layer,
APIs to connect the Verse to Web2 software not within The Verse and which serves the members of The Verse outside of the environment,
Human biometrics for identification purposes. (An example of this is a fingerprint scanner on your laptop or a face recognition scan on your phone.),
Next-generation user interfaces to support concurrent information streams and analysis. (These are shown in our Screens/Images shared within the document.) **Jim, these are the screens that we have shared in this document showing the data input, AI outputs and wallet dashboards for Crypto and other currencies,
Screens shared in the above document are also a desktop/mobile/devise example of Spatial Computing and reflect the specifics of our usability with flexible movement within that environment.

The following documents regarding Spatial Computing are incorporated herein by reference:
“Grid File index in Big Data Crowdsourcing”, Manal Abdulrahman Alharthi, Leena Solayman

Houmaidan, Ashwaq Ahmed Almalki, Louai Alarabi, 2022 2nd International Conference on Computing and Information Technology (ICCIT);
“What Is Spatial Computing? A Basic Explainer”, Ben Dickson, PC Magazine, Jan. 19, 2025;
“The seven layers of the metaverse”, LeeWayHerts.

### Web3.0—Definition and Method of Integration

Web3 Internet uses blockchain technology—the same technology that underpins cryptocurrencies and the banking systems of most of the major banks in Europe and America (USA)—which makes the decentralized Internet more secure and private. Web3 systems are technology protocols controlled by computer code to facilitate direct and secure communications among users, applications, and data. The defining attributes between Web2 and Web3 are shown described below.

### What are the 5 Layers of Web3 aka Blockchain Technology Stacks?

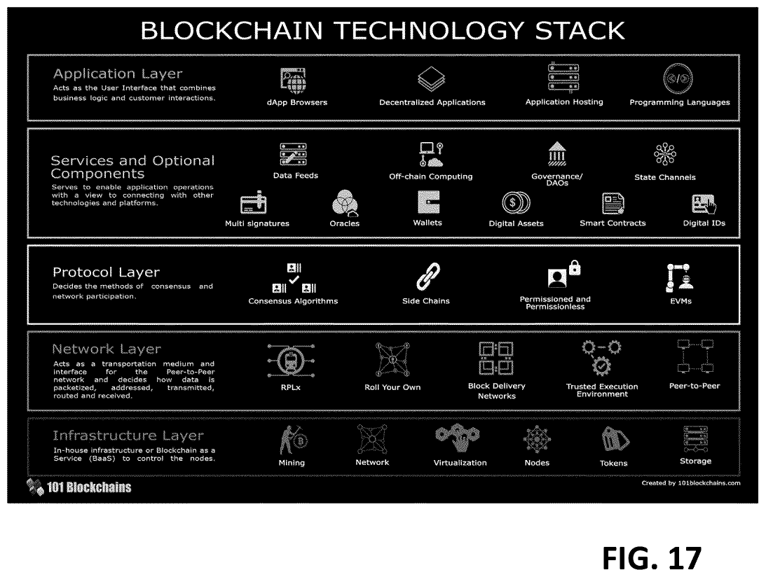

Blockchain consists of five layers: hardware infrastructure, data, network, consensus, and application layers (see FIG. 17). These layers handle functions from data storage to user-facing applications (see “A Beginner's Guide to Understanding the Layers of Blockchain Technology”, Blockchain Council, wherein is hereby incorporated by referenced).

### Application and Presentation Layer

The application layer consists of the programs that end-users take advantage of to establish blockchain network communication. Smart contracts, Dapps (decentralized applications), chaincode, scripts, UIs (user interfaces), APIs (application programming interfaces), and frameworks constitute the application layer.

The application layer and the execution layer are subdivisions of the application layer's protocols. The blockchain network acts as the back-end mechanism for the applications and communicates with the help of APIs. However, smart contracts, chaincode, and underlying protocols form the execution layer.

The constituting applications instruct the execution layer for the proper execution of transactions while ensuring the deterministic aspect of the blockchain platform.

Thus, the five layers of a blockchain that support the system. These five layers may also be referred to as layer-0, layer-1, and layer-2.

### Layer-0

Comprising hardware, protocols, connections, and other components that form the foundation of a blockchain ecosystem, Layer-0 acts as a network architecture underlying the blockchain. This layer may be thought of as a “network of blockchains.”

Inter-chain operability is also enabled by Layer 0, which allows blockchains to communicate with one another. It provides a critical backbone for addressing future layer scalability difficulties. Layer 0 often employs a native token to enable participation and development.

Polkadot, Avalanche, Cardano, and Cosmos are some examples of Layer 0.

### Layer-1

Layer-1 is responsible for carrying out the bulk of tasks that maintain a blockchain network's fundamental operations like dispute resolution, consensus mechanism, programming languages, protocols, and restrictions. Layer-1 symbolizes the actual blockchain.

The large number of jobs that this tier must manage frequently causes scalability problems. As more individuals enter a blockchain, the amount of computational power required to solve and add blocks to the chain grows, resulting in higher fees and longer processing times.

The scalability concern is somewhat mitigated by improved consensus techniques such as proof-of-stake and the advent of sharding (the division of computing operations into smaller parts). However, history has shown that they are insufficient.

Ethereum, Binance Smart Chain, Bitcoin, and Solana are all examples of Layer 1.

### Layer-2

To enhance the blockchain's productivity, extra processing power is required. However, this necessitates the inclusion of extra nodes, which clog the network. Although adding nodes is essential for sustaining a blockchain's decentralized character, fiddling with scalability, decentralization, or throughput will affect the others on layer 1.

As a result, layer 1 cannot be enlarged without relocating all processing to a second layer created on top of the first, that is layer 2. This is made feasible by allowing third-party solutions to be integrated with layer 1.

A new network, Layer-2, revamps Layer-1 and manages all the transactional validations. Layer-2 sits on top of Layer-1 in the blockchain ecosystem and constantly exchanges information with it. However, Layer-1 is only responsible for managing the addition and creation of new blocks to the blockchain.

For instance, consider the Lightning Network as an example of a layer 2 blockchain deployed on the Bitcoin blockchain.

### Layer-3

The last layer of the blockchain ecosystem and the one visible to the human eye. Layer-3 is the one where participants will eventually interact with the user interfaces (UI). When working with L1 and L2, this layer aims to give simplicity and ease.

L3 not only provides UI, but also utility in the form of intra-and inter-chain operability, such as decentralized exchanges, liquidity provisioning, and staking applications. Decentralized apps (dApps) are a type of layer 3 interface that provides real-world applications for blockchain technology.

Other examples include:
Decentralized crypto exchanges like Pancake Swap and Uniswap,
Wallet providers like Binance and Coinbase,
Liquidity management protocols like Compound and Aave, and,
Payment mechanisms like Tornado Cash.

Internet base layer will not be linked to example-A google search engine to manipulate the layers but will be linked to a Blockchain layer search and ledger system that we have created and is shown in the above example, that will then provide the security via Zero Knowledge proofs (cryptographic tools) to assure the security layer.

In basic form, a zero-knowledge proof is made up of three elements: witness (confidential Info), challenge, and response.

Witness: With a zero-knowledge proof, the prover wants to prove knowledge of some hidden information. The secret information is the “witness” to the proof, and the prover's assumed knowledge of the witness establishes a set of questions that can only be answered by a party with knowledge of the information. Thus, the prover starts the proving process by randomly choosing a question, calculating the answer, and sending it to the verifier.

Challenge: The verifier randomly picks another question from the set and asks the prover to answer it.

Response: The prover accepts the question, calculates the answer, and returns it to the verifier. The prover's response allows the verifier to check if the former really has access to the witness. To ensure the prover isn't guessing blindly and getting the correct answers by chance, the verifier picks more questions to ask. By repeating this interaction many times, the possibility of the prover faking knowledge of the witness drops significantly until the verifier is satisfied.

### The Application of Zero Knowledge Proof in BlockChains?

There are many applications of Zero Knowledge Proof. In this document, we will be covering applications of ZK in Block Chains:
Private transactions on blockchains: Transaction data is encrypted, and proof posted to prove it was computed correctly. ZKPs are also used in private transactions that do not reveal monetary data and receiver and sender information. An example is Tornado Cash, a decentralized, non-custodial service that allows users to conduct private transactions on Ethereum.
Performance optimizations: Application code is executed off-chain, or by a single node on the blockchain network, and only proof of its correct execution is posted to the blockchain for other parties to verify its correctness. An example is ZK Rollups, where transactions are executed off-chain and finally, a summary of all transactions is then submitted on-chain.
Transferring private blockchain transactions: The most notable concern in private blockchain transactions is the numerous loopholes evident in conventional procedures. The productive integration of ZKP with private blockchain transactions can create a powerful hacker-proof process.
Data Security and Privacy: Organizations that control sensitive data, such as banks and hospitals, must keep them free from third-party access. ZKPs and blockchain together can make accessing data impossible.

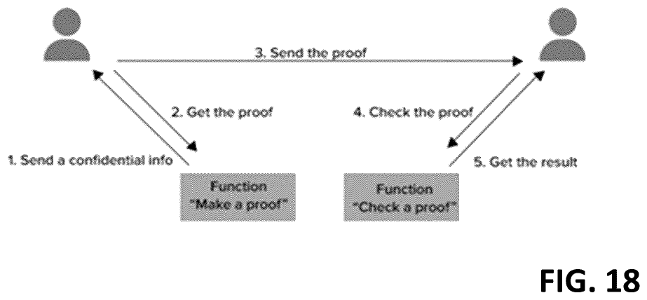

The Verse utilizes this technology stack as the basis for all of the actions of the environment. Therefore, all portions shown in FIG. 18 will be accessed to interact with the UI/UX driving the actions of the data to produce content, activate AI tools and traditional and new video/imaging tools all within this environment.

To use Spatial Computing on this stack, the following are used as primary labels within the stack:
Unity as the code programming language with a dapp browser (The Verse as the application hosting within those multiple decentralized applications),
Second stage/services layer is the tools within The Verse,
Digital Wallet-with regulatory exchange and offerings shared before Crypto/usd/gbp/Euro,
Smart contracts to run within blockchain for management of the member accounts,
Digital IDs in two forms-QR code and a Smart contract,
Governance via software package not available yet,
Data feed between,
Protocol Layer or Consensus,
Algorithms/Side chains/permission Zero knowledge proofs/EVM,
Network layer,
Infrastructure
Network/Virtualization/nodes/Tokens (NFT)/Storage

The following documents are hereby incorporated by reference:
“Zero-Knowledge Proof in Blockchain Explained”, QuillAudits, Oct. 19, 2022,
“A Beginner's Guide to Understanding the Layers of Blockchain Technology”, BlockChain Council.

### Aggregation of Content/Data from Web3 to Web2

Aggregation meaning in this document is for us to gather information which has been selected via the User Interface and then organize it in a data/object structure approved by the UI/User and send it to the designated Web2 application outside of The Verse using an API (Web3 environment). “An application programming interface is a way for two or more computer programs or components to communicate with each other. It is a type of software interface, offering a service to other pieces of software.” (Wikipedia).

The screen shown below is an aggregation screen for an influencer which shows that the text (long or short form), video (long or short form) can be sent out of The Verse and “aggregated” within an API (Application programming interface) landing inside each of the specifically selected web2 platforms without having to log into that platform and post, this is an automated function/series of code executed and sent via the API. Since all current Web2 platforms, within the Web2 social media space, already provide APIs for ad usage and sharing of data/transactions, these are pre-approved for us to use.

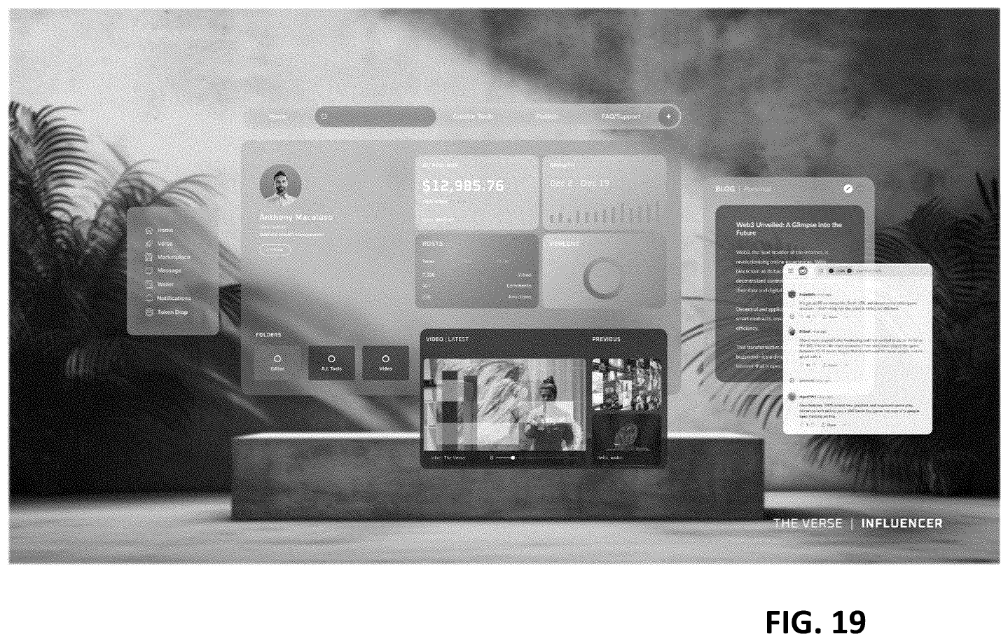

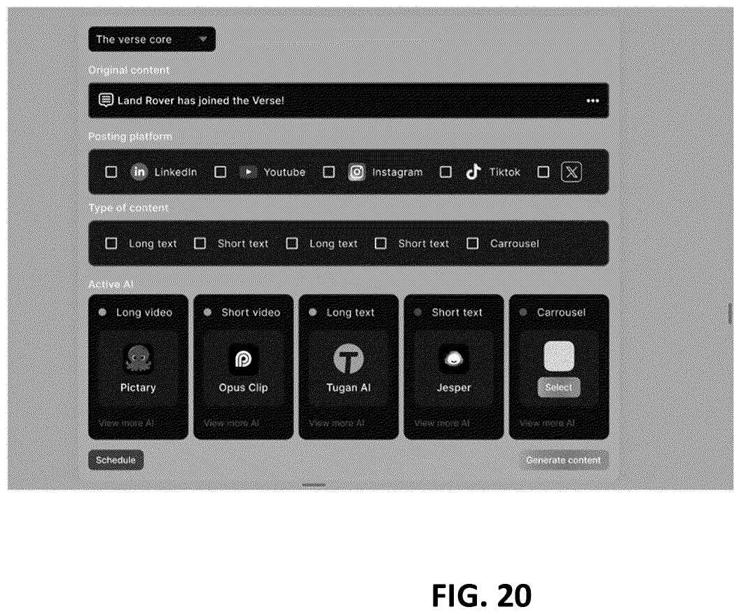

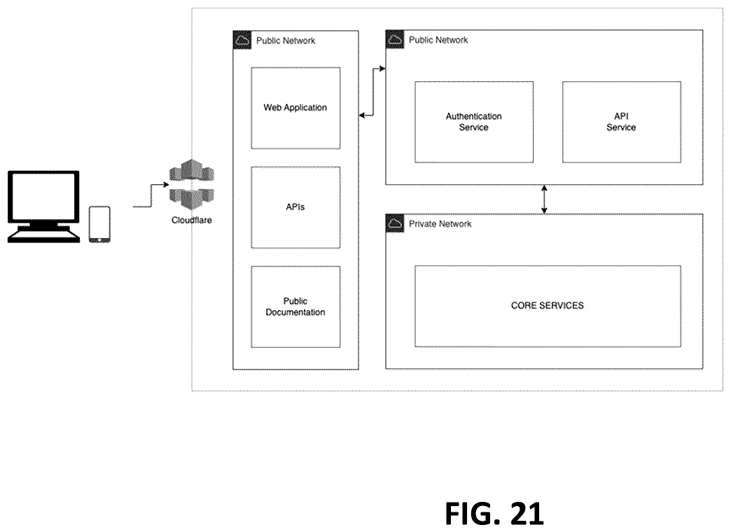

As seen in the Verse Influencer MVP UI/UX screen, the creator will generate text or a video internally with Web3 and AI tools, then with the next below screenshot, selection from the UI/UX can be by mouse click and execute via the API sent for an automatic posting within the Web2 social media platform. This will be done via Web3 application tools, and the APIs selected within the code (see FIGS. 19-21).

### Glossary

Altcoin: Short for alternative coins, referring to cryptocurrencies other than Bitcoin.

Artificial Intelligence (AI): The theory and development of computer systems that can perform tasks—often using natural language processing (NLP), machine learning and natural language understanding (NLU)—that normally require human intelligence, comprehension and understanding.

Augmented Reality (AR): Technology, using involving glasses, visors, goggles or smartphones, which superimposes a computer-generated image on a user's view of the actual world, providing a composite view that often includes perceptual information.

Avatar: A computerized icon or figure which represents a person, pet or entity in video games, internet forums, games, chat rooms, virtual reality and other channels.

Block: A place in a blockchain where data is stored and encrypted.

Blockchain: A shared, immutable digital ledger that records and maintains transactions and tracks assets across a peer-to-peer business network.

Bitcoin: A decentralized, digital cryptocurrency that doesn't rely upon a central bank or trusted source which can be transferred from user to user on a peer-to-peer network using blockchain technology.

ChainLink: A cryptocurrency with a goal of incentivizing a global network of computers to provide reliable, real-world data to smart contracts running on top of blockchains.

Consensus Mechanism: A fault-tolerant process used in blockchain systems to obtain the necessary agreement on a single data value or a single state of the network among distributed processes or multi-agent systems, typically with cryptocurrencies.

Creator Economy: A class of businesses made up of content creators, curators and community builders which enable the content producers to monetize their creations.

Cryptocurrency: A digital currency—designed to work as a medium of exchange—in which transactions are verified and records maintained by a decentralized computer network using cryptography, rather than going through a centralized, trusted authority.

Cryptography: The computerized practice of encoding and decoding information for secure communication.

Crypto Wallet: A physical or digital device, computer application or smartphone app that stores the public and/or private keys for cryptocurrency transactions, including sending, receiving, buying, selling, swapping of cryptocurrencies and NFTs and digitally signing information.

Decentralization: The transfer of control and decision-making from a centralized, trusted authority (i.e., an individual, organization, group, government, etc.) to a distributed network.

Decentralized Applications (dApps): An application that can operate autonomously using smart contracts on a peer-to-peer network of computers or a decentralized computing, blockchain system.

Decentralized Autonomous Organization (DAO): A group or entity that is represented by rules that are controlled by its members and not influenced or controlled by a central government or power—all governance is done as part of a group or collective.

Decentralized Finance (DeFi): Enables peer-to-peer financial services without reliance on intermediaries such as brokerages, exchanges or banks through the use of smart contracts on a public blockchain.

Digital Identity: The online or networked identity of a person, organization, application or device that is used by computer systems or applications to represent an external agent.

Digital Twin (NFT): A virtual or 3D digital representation that is identical to the real-time version of a physical object or process.

Distributed Ledger: A ledger or database of replicated, shared and synchronized digital data that is maintained in a decentralized form that is spread across multiple sites, countries or institutions without using a central administrator.

Distributed Ledger Technology (DLT): The technological infrastructure and protocols, also known as blockchain technology, which enables simultaneous access, validation and record updating in an immutable manner across a geographically diverse network made up of multiple entities.

Ethereum: A decentralized, open-source blockchain platform with smart contract functionality that is powered by blockchain technology. It is known for its native cryptocurrency, called ether (ETH), and the Dapps that run on its network.

Ethereum Request for Comment (ERC): A standard protocol that is used to issue tokens under the Ethereum platform, ERC refers to the technical documents that are used by smart contract developers at Ethereum to define the set of rules required to implement tokens for the Ethereum ecosystem.

Ether (ETH): The native cryptocurrency of the Ethereum network that is bought, sold and exchanged on cryptocurrency exchanges.

Extended Reality (XR): An environment or experience that combines virtual and physical realities through the use of augmented reality (AR), mixed reality, virtual reality (VR) or any similar immersive technologies.

Events: Events are activities/happenings. They may be planned events, or they may be completely spontaneous, virtual or in real life. Users/Members/Influencers/Businesses may have their own events, ecommerce should be able to be attached to any Event.

GameFi: An amalgam of the words gaming and decentralized finance (DeFi), GameFi refers to play-to-earn (P2E) games.

Gas: The fee or pricing value that is charged for successfully conducting a transaction or executing a contract on a blockchain platform.

Hard Fork: A major change to a distributed network's blockchain protocol that makes previously invalid blocks and transactions valid, or vice-versa; this occurs when the code changes so much that the new version is no longer backward-compatible with earlier blocks.

Hash Function: A mathematical one-way cryptographic algorithm that maps an input of arbitrary size to a unique output of a fixed length of bits.

Immersive Social: Enables users to explore and interact with 3D environments and collaborate with other users in a virtual space, all of which facilitates a richer, more compelling, personal way of sharing experiences and relating to one another.

InterPlanetary File System (IPFS): A protocol and distributed peer-to-peer network for storing and sharing data via a distributed file system.

Machine Intelligence: An umbrella term that describes the accuracy of machine learning (ML), deep learning (DL) or classical algorithm output; also refers to artificial intelligence (AI).

Machine Learning (ML): A part of artificial intelligence; refers to algorithms that can improve automatically through experience and the use of data without human intervention.

Meta: The new name of the company that owns Facebook; Mark Zuckerberg said the name Meta “reflects the full breadth of what we do and the future we want to help build.” Meta aims to be a major player in the metaverse.

MetaMask: A software cryptocurrency wallet, MetaMask is available as a browser extension and mobile app and features a key vault, secure login, token wallet and token exchange, and interacts with the Ethereum blockchain.

Metaverse: The still-evolving concept of a 3D, virtual network with a focus on social connections. It is not Web3, but it is seen as a part of Web3, the concept of which is a hypothetical iteration of the internet as a single, unified virtual world that is accessed through VR or AR headsets.

Mixed Reality (MR): Mixed reality is the merging of physical and virtual worlds to produce new environments and visualizations, where physical and digital objects co-exist and interact in real-time; the key difference is between mixed reality and augmented reality is the user's ability to interact.

Non-Fungible Token (NFT): A non-interchangeable cryptographic unit of data with unique identification codes and metadata that distinguishes it from another. This form of digital ledger is stored on a blockchain and can be sold and traded. NFTs are typically associated with digital files, including videos, images and audio.

Open Platform: A platform based on open standards that allows developers to build applications or services that work on the platform.

Permissionless: Refers to permissionless or trustless blockchains, which are open networks that allow everyone to participate in the consensus process, which itself uses blockchains to validate transactions and data.

Proof of Stake (PoS): A cryptocurrency consensus mechanism used for processing transactions, creating new blocks on a blockchain, validating entries into a distributed database and keeping the database secure.

Proof of Attendance Protocol (POAP): An acronym for Proof of Attendance Protocol, a type of NFT “badge” that is given out to prove attendance at an event that has taken place in either the virtual and/or real world.

Proof of Work (PoW): A cryptographic method of verifying and tracking the creation of new cryptocurrency and transactions that occur on a blockchain by measuring the amount of a specific computational effort expended.

Private Key: A digital, cryptographic key used to decrypt messages that are received from the sender who used a public key to encrypt it.

Public-Key Cryptography: A cryptographic technique that uses a paired public and private key algorithm for secure digital communication. The sender's public key encrypts the message, and the recipient's private key decrypts a message.

Public Key: A digital, cryptographic key that can be obtained and used to encrypt messages sent to a specific recipient who uses the private key to decrypt it.

Smart Asset: Unique virtual currency tokens that may represent a tangible physical asset (such as a car) or non-tangible ownership (such as a Bitcoin) that can be bought, sold or traded as defined by smart contracts that are on the blockchain network.

Smart Contract: A computer program or a transaction protocol that defines the terms of an agreement, with those terms being executed as code that is running on a blockchain; enables developers to create apps that utilize blockchain security, reliability and accessibility.

Soft Fork: A change to a software protocol in which only previously valid transaction blocks are made invalid; since old nodes will recognize new blocks as valid, a soft fork is backwards-compatible, the opposite of a hard fork.

Solana: A public blockchain platform with smart contract functionality, faster transaction times and lower costs than Ethereum. Like Ethereum, it can host decentralized, scalable applications, and while Ethereum limits transactions to 15-30 per second, Solana can handle as many as 50,000.

Solidity: An object-oriented programming language used for constructing and designing smart contracts on blockchain platforms such as Ethereum.

Spatial Computing: Spatial computing is a technology that enables computers to blend in with the physical world in a natural way. It relies on several technologies to mix the digital and physical worlds. They use computer vision, which processes data from cameras and other sensors and captures visual information about the environment, including the position, orientation, and movement of objects. With sensor fusion, they can combine data from multiple sensors, such as cameras and LiDARs , to create an accurate and comprehensive view of the environment. And they use spatial mapping to create a 3D model of the environment, which allows for more precise placement and manipulation of digital content.

Stablecoin: Cryptocurrencies that attempt to offer stability due to the price being backed by a cryptocurrency, fiat money or exchange-traded commodities.

State: A snapshot of a blockchain system at a specific point in time, which includes multiple aspects such as the order of transactions, amount per transaction and account balances.

Token: A digital currency token or a denomination of a cryptocurrency (such as Bitcoin or Ether coin) that represents a tradable asset or utility on its own blockchain and enables the holder to use it for investment or economic purposes.

Trustless: A core element of blockchain, crypto payments and smart contracts, trustless refers to the fact that transactions don't rely on trusting a third party such as a bank or other entity.

Verses: Verses are user spaces. A User's Verse could be customized for their role. Theme can pertain to the name or the background or the content that is posted. A Verse has its own content not limited to but usually related to that Influencer or Organization.

Virtual Currency: A digital representation of currency, typically cryptocurrencies, which can only exist in electronic form, can be accepted for goods and services and can be bought, sold and traded via cryptocurrency exchanges.

Virtual Economy: An emergent economy that exists in a digital virtual world, where virtual goods are bought, sold and exchanged using virtual currency in the context of an online game.

Virtual Reality (VR): A computer-generated simulation of a three-dimensional environment that can be interacted with by a person or group of people using special hardware, such as a set of electronic goggles, gloves, or haptic devices.

Web3: The third generation of online services for websites and applications with core concepts of blockchain-based decentralization, AR/VR-based immersive technologies and AI-based semantics, all of which facilitate transparent, ubiquitous, open, vibrant virtual experiences.

Zero Knowledge Protocol: Zero Knowledge Protocol (or Zero Knowledge Password Proof, ZKP) is a way of doing authentication where no passwords are exchanged, which means they cannot be stolen.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. A system for providing a social network to a plurality of users, comprising:
a memory device storing a system executing program including computer instructions, the system executing program configured to implement the social network as a Web 3.0 platform;
a database for storing user account records and data associated with user virtual spaces, each user account record and each user virtual space being associated with one of the users, each user account including a current level, a number of engagement points, and a virtual currency value;
user applications, each user application, stored in memory of a user device associated with one of the users;
a server system coupled to the memory device, the database and the user applications, the server system including a processor programmed to execute the system execution program for each user to perform the steps of:
allowing the user, via the user application, to establish and maintain the associated virtual space,
allowing the user, via the user application, to create and maintain content within the associated virtual space,
aggregating the content of the user to Web 2.0 platforms and allowing users to interact with the content on the Web 2.0 platforms,
allowing the user, via the user application, to interact with content in the virtual spaces associated with other users,
providing, and storing within the user account, engagement points and/or virtual currency as a function of the interaction with the content in the virtual spaces associated with other users, and,
managing the user's current level as a function of the engagement points and/or virtual currency stored in their account.

2. The system, as set forth in claim 1, wherein the user account includes a virtual wallet, the number of engagement points and virtual currency value being stored within the virtual wallet.

3. The system, as set forth in claim 2, wherein the user application is configured to allow the user to purchase engagement points and/or virtual currency with real-world currency.

4. The system, as set forth in claim 2, wherein at least some of the content requires payment of engagement points and/or virtual currency to access.

5. A method system for providing a social network to a plurality of users, comprising:
storing a system executing program including computer instructions, in a memory device, the system executing program configured to implement the social network as a Web 3.0 platform;
storing user account records and data associated with user virtual spaces in a database, each user account record and each user virtual space being associated with one of the users, each user account including a current level, a number of engagement points, and a virtual currency value;
providing user applications, each user application, stored in memory of a user device associated with one of the users;
executing the system execution program for each user on a processor of a server system coupled to the memory device, the database and the user applications, the system execution program performing the steps of:
allowing the user, via the user application, to establish and maintain the associated virtual space,
allowing the user, via the user application, to create and maintain content within the associated virtual space,
aggregating the content of the user to Web 2.0 platforms and allowing users to interact with the content on the Web 2.0 platforms,
allowing the user, via the user application, to interact with content in the virtual spaces associated with other users,
providing, and storing within the user account, engagement points and/or virtual currency as a function of the interaction with the content in the virtual spaces associated with other users, and,
managing the user's current level as a function of the engagement points and/or virtual currency stored in their account.

6. The method, as set forth in claim 5, wherein the user account includes a virtual wallet, the number of engagement points and virtual currency value being stored within the virtual wallet.

7. The method, as set forth in claim 6, wherein the user application is configured to allow the user to purchase engagement points and/or virtual currency with real-world currency.

8. The method, as set forth in claim 6, wherein at least some of the content requires payment of engagement points and/or virtual currency to access.

9. A non-transitory computer-readable medium comprising one or more computer-executable instructions that, when executed by at least one processor of a server system being configured to implement the social network as a Web 3.0 platform by performing the steps of:
storing user account records and data associated with user virtual spaces in a database, each user account record and each user virtual space being associated with one of the users, each user account including a current level, a number of engagement points, and a virtual currency value;
providing user applications, each user application, stored in memory of a user device associated with one of the users;
executing the system execution program for each user on a processor of a server system coupled to the memory device, the database and the user applications, the system execution program performing the steps of:
allowing the user, via the user application, to establish and maintain the associated virtual space,
allowing the user, via the user application, to create and maintain content within the associate virtual space,
aggregating the content of the user to Web 2.0 platforms and allowing users to interact with the content on the Web 2.0 platforms,
allowing the user, via the user application, to interact with content in the virtual spaces associated with other users,
providing, and storing within the user account, engagement points and/or virtual currency as a function of the interaction with the content in the virtual spaces associated with other users, and,
managing the user's current level as a function of the engagement points and/or virtual currency stored in their account.

10. The non-transitory computer-readable medium, as set forth in claim 9, wherein the user account includes a virtual wallet, the number of engagement points and virtual currency value being stored within the virtual wallet.

11. The non-transitory computer-readable medium, as set forth in claim 10, wherein the user application is configured to allow the user to purchase engagement points and/or virtual currency with real-world currency.

12. The non-transitory computer-readable medium, as set forth in claim 10, wherein at least some of the content requires payment of engagement points and/or virtual currency to access.
